(19) United States
(12) Patent Application Publication
(10) Pub. No.: US 2024/0381859 A1
(43) Pub. Date: Nov. 21, 2024

(54) SPINNERBAIT KIT

(71) Applicant: Douglas Johnson, Palos Hills, IL (US)

(72) Inventor: Douglas Johnson, Palos Hills, IL (US)

(21) Appl. No.: 18/199,773

(22) Filed: May 19, 2023

(51) Int. Cl. A01K 85/00; A01K 85/10

(52) U.S. Cl. CPC A01K 85/029; A01K 85/10; A01K 85/1877

(57) ABSTRACT

A quick-change spinnerbait system for containing a plurality of interchangeable components being selectively couplable to each other includes a wire being elongated and coupling to a fishing line. A lure is coupled to the wire and catches fish when the lure is positioned in water and pulls fish coupled to the lure when the fishing line pulls the wire. A sleeve is coupled to the lure and has a decorative indicia on an exterior of the sleeve, wherein the decorative indicia the sleeve attracts fish to the lure. A first housing is coupled to the wire and a first insert is insert within the first housing and attracts fish to the wire. A second housing is coupled to the wire and second insert is inserted within the second housing and attracts fish to the wire. A plurality of reflective members is coupled to the wire and attracts fish towards the wire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing lures and more particularly pertains to a new fishing lure for containing a plurality of interchangeable components being selectively couplable to each other.

### (2) Description of Related Art Including Information Disclosed Under 37 CFR 1.97 and 1.98

The prior art relates to fishing lures and includes a variety of fishing lures containing a plurality of interchangeable components provided in a kit. Known prior art does not allow the plurality of interchangeable components of a fishing lure to be selectively couplable to each other to form new fishing bait components.

### BRIEF SUMMARY OF THE INVENTION

An embodiment of the disclosure meets the needs presented above by generally comprising a wire being elongated and being configured for removably coupling to a fishing line. A lure is coupled to the wire and is configured for catching fish when the lure is positioned in water and pulling fish coupled to the lure when the fishing line pulls the wire. A sleeve is removably couplable to the lure and has a decorative indicia on an exterior of the sleeve, wherein the decorative indicia of the sleeve is configured for attracting fish to the lure. A first housing is removably couplable to the wire and encloses an interior space. A first insert is removably insertable within the interior space of the first housing and is configured for attracting fish to the wire. A second housing is removably couplable to the wire and encloses a receiving space. A second insert is removably insertable within the receiving space of the second housing and is configured for attracting fish to the wire. A plurality of reflective members is coupled to the wire and is configured for attracting fish towards the wire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a quick-change spinnerbait system according to an embodiment of the disclosure.

FIG. 2 is a detail view of an embodiment of the disclosure.

FIG. 3 is a detail view of an embodiment of the disclosure.

FIG. 4 is a detail view of an embodiment of the disclosure.

FIG. 5 is a detail view of an embodiment of the disclosure.

FIG. 6 is an in-use view of an embodiment of the disclosure.

### DETAILED DESCRIPTION OF THE INVENTION

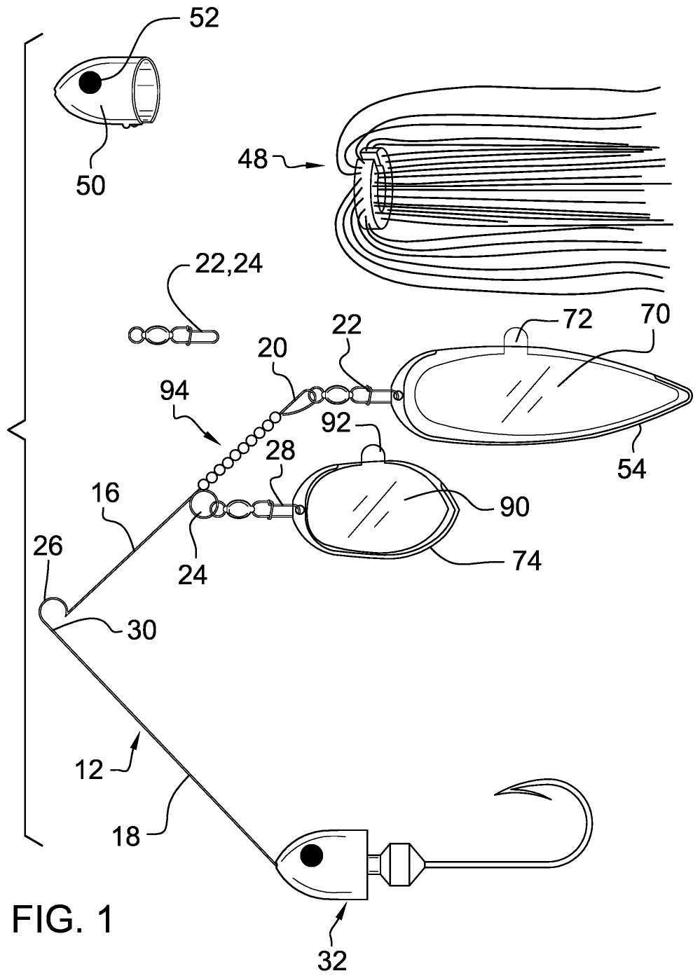

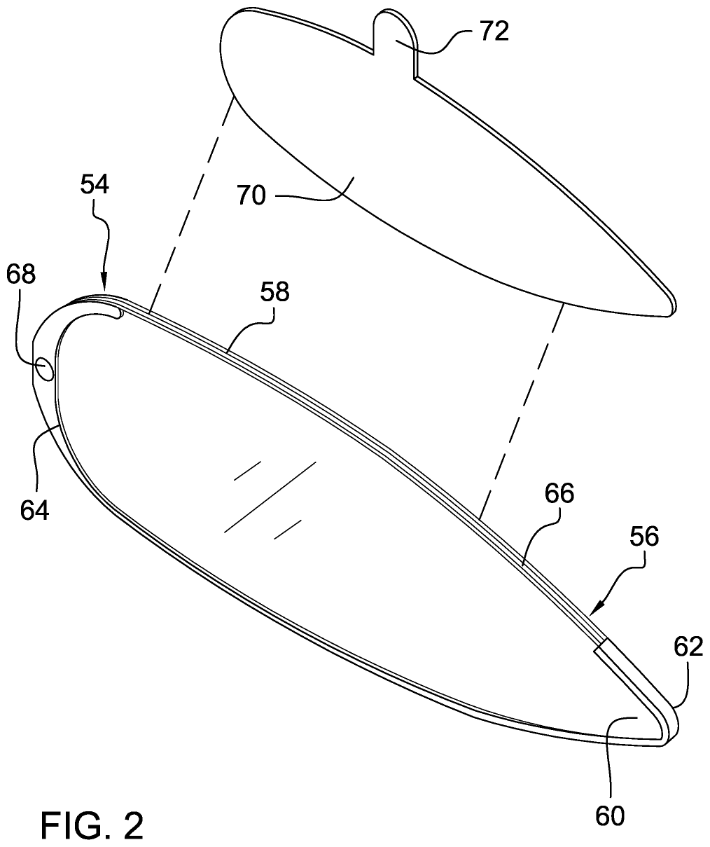

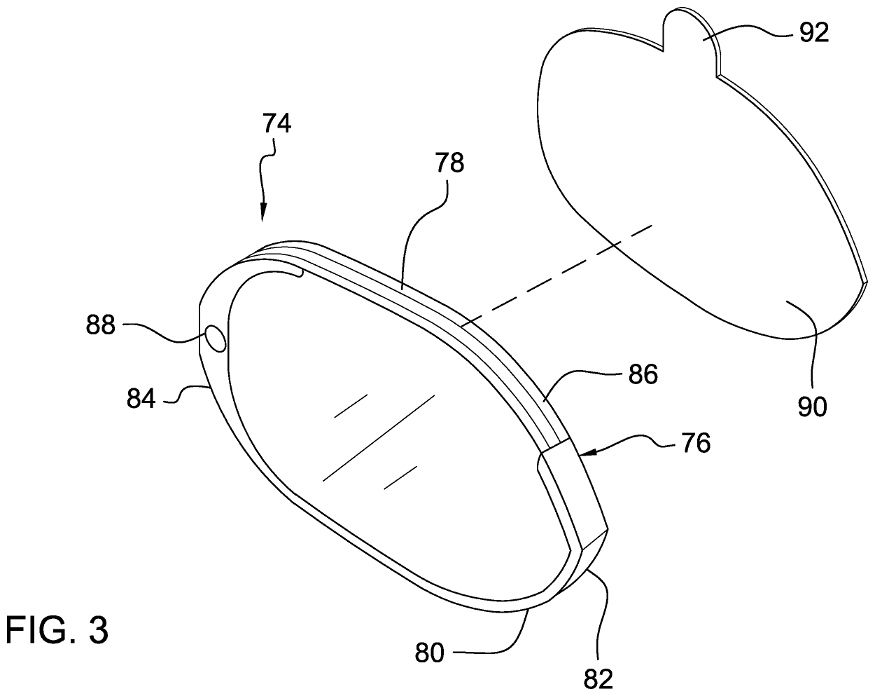

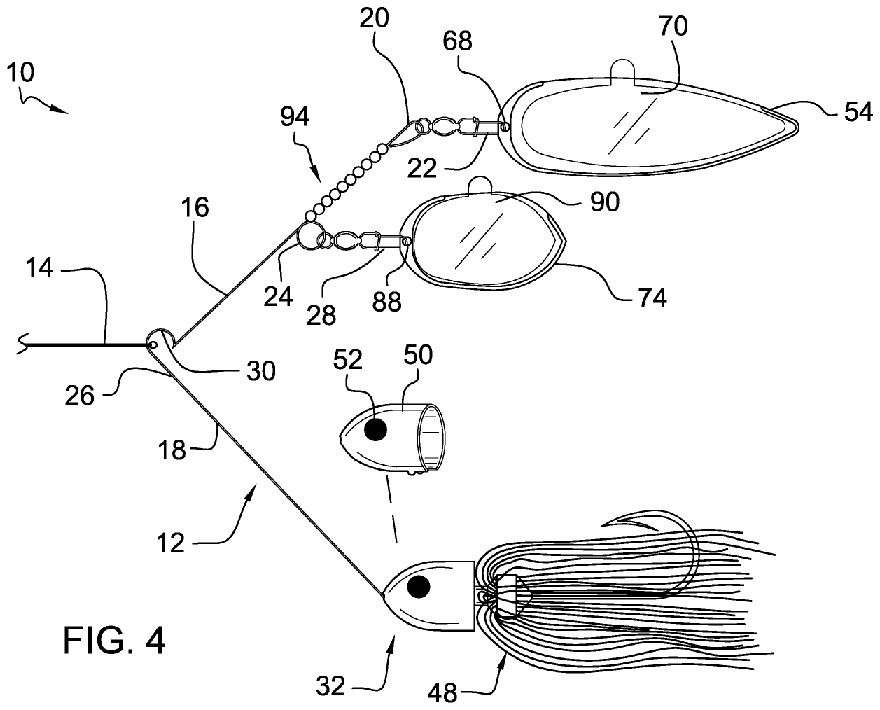

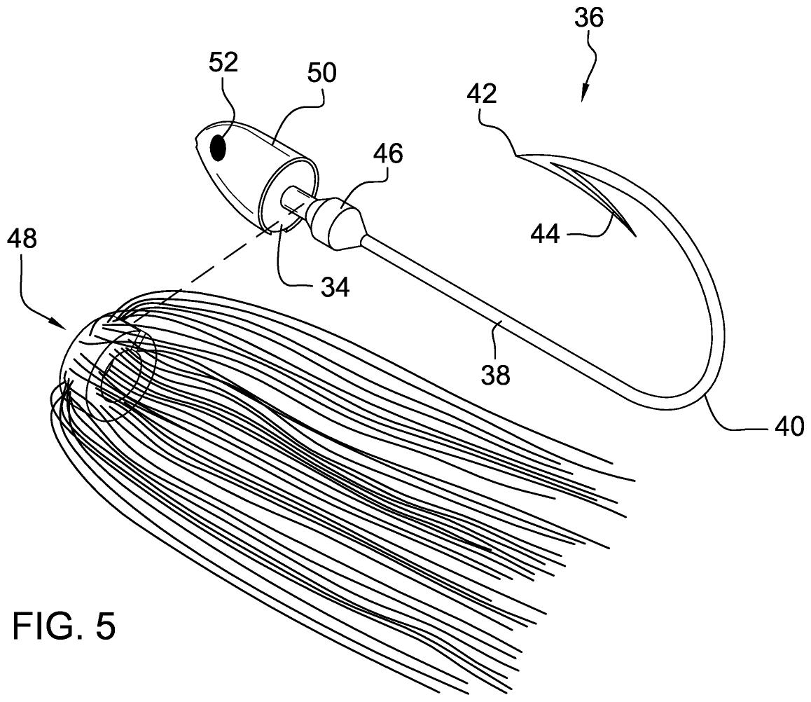

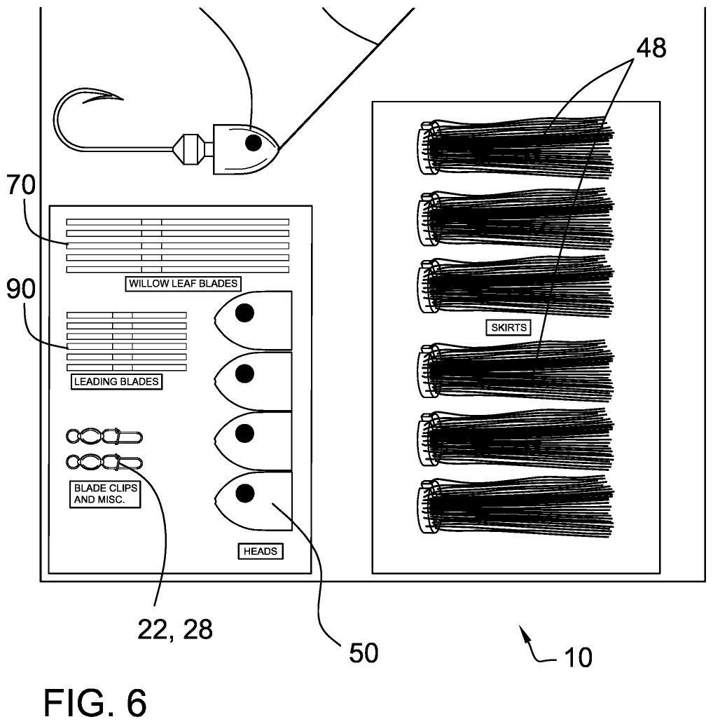

With reference now to the drawings, and in particular to FIGS. 1 through 6 thereof, a new fishing lure embodying the principles and concepts of an embodiment of the disclosure and generally designated by the reference numeral 10 will be described.

As best illustrated in FIGS. 1 through 6, the quick-change spinnerbait system 10 generally comprises a wire 12 being elongated and being configured for removably coupling to a fishing line 14. The wire 12 includes a first lateral section 16 and a second lateral section 18. The wire 12 typically comprises a resiliently flexible metal such as aluminum, brass, or copper, wherein the first lateral section 16 and the second lateral section 18 are adjustably positionable to each other by bending the first lateral section 16 or the second lateral section 18. An end of the first lateral section 16 has a first juncture 20 configured for removably coupling to a first coupler 22. A second juncture 24 is coupled to the first lateral section 16 and is equally spaced between the first juncture 20 and a junction 26 of the first lateral section 16 and the second lateral section 18. The second juncture 24 is configured for removably coupling to a second coupler 28. The first coupler 22 and the second coupler 28 normally each comprise a quick release swivel typically used on a conventional spinnerbait. The junction 26 of the first lateral section 16 and the second lateral section 18 has a third juncture 30 configured for releasably fastening to the fishing line 14. The first 20, second 24, and third 30 junctures each may comprise a loop extending from a same side and are coplanar with the first lateral section 16 and the second lateral section 18. The first 20, second 24, and third 30 junctures extend from the first lateral section 16 towards the second lateral section 18, wherein the first 20, second 24, and third 30 junctures are positioned between the first lateral section 16 and the second lateral section 18.

A lure 32 is coupled to the wire 12 and is configured for catching fish when the lure 32 is positioned in water and pulling fish coupled to the lure 32 when the fishing line 14 pulls the wire 12. The lure 32 normally includes a head 34, wherein a nose of the head 34 is coupled to a second end of the second lateral section 18 of the wire 12. The head 34 is a fish head shape configured for attracting other fish. A hook 36 is coupled to and extends outwardly from the head 34. The hook 36 has a shank 38 coupled to a back side of the head 34 and extends towards a bend 40. An end of the bend 40 has a point 42 and a barb 44. The point 42 is configured to insert through a fish and the barb 44 is configured to retain the fish within the hook 36.

A lead 46 is coupled to the hook 36 and is configured for releasably coupling to a washer and skirt assembly 48. The lead 46 is positioned proximate to the head 34 and may comprise a hexagonal shape configured to secure the washer and skirt assembly 48 within a fixed position upon the hook 36. A sleeve 50 is removably couplable to the lure 32 and has a decorative indicia 52 on an exterior of the sleeve 50, wherein the decorative indicia 52 of the sleeve 50 is configured for attracting fish to the lure 32. The sleeve 50 is the fish head shape, wherein the sleeve 50 removably covers the head 34 of the lure 32. The decorative indicia 52 may include an illustration of a selective fish head, wherein the sleeve 50 may attract a selective fish towards the lure 32.

A first housing 54 is removably couplable to the wire 12 and encloses an interior space 56. The first housing 54 comprises a first shape 58 typically being a willow leaf blade shape or another conventional spinnerbait blade shape. The first housing 54 includes a first wall 60, a second wall 62, and a perimeter edge 64. The perimeter edge 64 has an opening 66 to the interior space 56 therein. A hole 68 extends through the perimeter edge 64 and is configured for removably coupling to the first coupler 22, wherein the first housing 54 is removably couplable to the first juncture 20 of the wire 12.

A first insert 70 is removably insertable within the interior space 56 of the first housing 54 and is configured for attracting fish to the wire 12. A top side of first insert 70 may have a tab 72 coupled to and extends from the top side. The tab 72 is removably positioned within the opening 66 of the first housing 54 when the first insert 70 is removably positioned within the interior space 56 of the first housing 54, wherein the tab 72 is graspable by a user to facilitate removing the first insert 70 from the first housing 54. The first insert 70 typically is a willow leaf blade shape, wherein the willow leaf blade shape of the first insert 70 corresponds to the willow leaf blade shape of the first housing 54.

A second housing 74 is removably couplable to the wire 12 and encloses a receiving space 76. The second housing 74 comprises a second shape 78 typically being a Colorado blade shape or another conventional spinnerbait blade shape. The second housing 74 includes a primary wall 80, a secondary wall 82, and a boundary edge 84. The boundary edge 84 has an access 86 to the receiving space 76 therein. An aperture 88 extends through the boundary edge 84 and is configured for removably coupling to the second coupler 28, wherein the second housing 74 is removably couplable to the second juncture 24 of the wire 12.

A second insert 90 is removably insertable within the receiving space 76 of the second housing 74 and is configured for attracting fish to the wire 12. An upper side of second insert 90 may have a tag 92 coupled to and extends from the upper side. The tag 92 is removably positioned within the access 86 of the second housing 74 when the second insert 90 is removably positioned within the receiving space 76 of the second housing 74, wherein the tag 92 is graspable by a user to facilitate removing the second insert 90 from the receiving space 76 of the second housing 74. The second insert 90 typically is a Colorado blade shape, wherein the Colorado blade shape of the second insert 90 corresponds to the Colorado blade shape of the second housing 74.

A plurality of reflective members 94 is coupled to the wire 12 and is configured for attracting fish towards the wire 12. The reflective members 94 are coupled to the first lateral section 16 and are normally positioned between the first juncture 20 and the second juncture 24. Each reflective member 94 typically comprises a bead having a hollow shaft extending through a center of the bead, wherein the wire 12 is inserted in each reflective member 94.

In use, the first housing 54 is coupled to the first coupler 22 and the second housing 74 is coupled to the second coupler 28, wherein the first housing 54 and the second housing 74 are coupled to the wire 12. The sleeve 50 may cover the head 34 of the lure 32 to facilitate attracting selective fish to the lure 32. The lead 46 of the lure 32 receives the washer and skirt assembly 48 to enhance attracting fish to the lure 32. The first insert 70 is inserted into the interior space 56 of the housing and the second insert 90 is inserted into the receiving space 76 of the second housing 74. The third juncture 30 of the junction 26 of the first lateral section 16 and the second lateral section 18 fastens to a fishing line 14 prior to inserting the wire 12 into water to attract fish.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A spinnerbait system comprising:
a wire being elongated and being configured for removably coupling to a fishing line;
a lure being coupled to said wire and being configured for catching fish when said lure is positioned in water, said lure being configured for pulling fish coupled to said lure when the fishing line pulls said wire;
a sleeve being removably couplable to said lure and having a decorative indicia on an exterior of said sleeve, wherein said decorative indicia of said sleeve is configured for attracting fish to said lure;
a first housing being removably couplable to said wire and enclosing an interior space;
a first insert being removably insertable within said interior space of said first housing and being configured for attracting fish to said wire;
a second housing being removably couplable to said wire and enclosing a receiving space;
a second insert being removably insertable within said receiving space of said second housing and being configured for attracting fish to said wire;
a plurality of reflective members being coupled to said wire and being configured for attracting fish towards said wire;
wherein said wire includes a first lateral section and a second lateral section, a first end of said first lateral section having a first juncture configured for removably coupling to a first coupler, a second juncture being coupled to said first lateral section and being equally spaced between said first juncture and a junction of said first lateral section and said second lateral section, said second juncture being configured for removably coupling to a second coupler, said junction having a third juncture, said third juncture being configured for releasably fastening to the fishing line, said first, second, and third junctures each comprising a loop extending from a same side and being coplanar with said first lateral section and said second lateral section, said first, second and third junctures extending from said first lateral section towards said second lateral section, wherein said first, second, and third junctures are positioned between said first lateral section and said second lateral section; and
wherein said first housing comprises a first shape, said first shape being a willow leaf blade shape, said first housing including a first wall, a second wall, and a perimeter edge, said perimeter edge having an opening to said interior space therein such that said first insert is partially surrounded when inserted into said interior space of said first housing, a hole extending through said perimeter edge and being configured for removably coupling to the first coupler, wherein said first housing is removably couplable to said first juncture of said wire.

2. (canceled)

3. The spinnerbait system of claim 1, wherein said lure includes a head, a nose of said head being coupled to a second end of said second lateral section of said wire.

4. The spinnerbait system of claim 3, further including a hook being coupled to and extending outwardly from said head, said hook having a shank being coupled to a back side of said head and extending towards a bend, an end of said bend having a point and a barb, said point being configured to insert through a fish and said barb is configured to retain the fish within the hook.

5. The spinnerbait system of claim 4, further including a lead being coupled to said hook and being configured for releasably coupling to a washer and skirt assembly, said lead being positioned proximate to said head, said lead comprising a hexagonal shape configured to secure the washer and skirt assembly within a fixed position upon said hook.

6. The spinnerbait system of claim 3, wherein said sleeve removably covers said head of said lure.

7. (canceled)

8. The spinnerbait system of claim 1, wherein a top side of first insert has a tab coupled to and extending from said top side, said tab being removably positioned within said opening of said first housing when said first insert being removably positioned within said interior space of said first housing, said first insert being a willow leaf blade shape.

9. The spinnerbait system of claim 1, wherein said second housing comprises a second shape, said second shape being a Colorado blade shape, said second housing including a primary wall, a secondary wall, and a boundary edge, said boundary edge having an access to said receiving space therein, an aperture extending through said boundary edge and being configured for removably coupling to the second coupler, wherein said second housing is removably couplable to said second juncture of said wire.

10. The spinnerbait system of claim 9, wherein an upper side of second insert has a tag coupled to and extending from said upper side, said tag being removably positioned within said access of said second housing when said second insert being removably positioned within said receiving space of said second housing, said second insert being a Colorado blade shape.

11. The spinnerbait system of claim 1, wherein said plurality of reflective members is coupled to said first lateral section, said plurality of reflective members being positioned between said first and second junctures, each reflective member comprising a bead having a hollow shaft extending through a center of said bead, wherein said wire is inserted within each reflective member.

12. A spinnerbait system comprising:
a wire being elongated and being configured for removably coupling to a fishing line, said wire including a first lateral section and a second lateral section, a first end of said first lateral section having a first juncture configured for removably coupling to a first coupler, a second juncture being coupled to said first lateral section and being equally spaced between said first juncture and a junction of said first lateral section and said second lateral section, said second juncture being configured for removably coupling to a second coupler, said junction having a third juncture, said third juncture being configured for releasably fastening to the fishing line, said first, second, and third junctures each comprising a loop extending from a same side and being coplanar with said first lateral section and said second lateral section, said first, second and third junctures extending from said first lateral section towards said second lateral section, wherein said first, second, and third junctures are positioned between said first lateral section and said second lateral section;
a lure being coupled to said wire and being configured for catching fish when said lure is positioned in water, said lure being configured for pulling fish coupled to said lure when the fishing line pulls said wire, said lure including:
a head, a nose of said head being coupled to a second end of said second lateral section of said wire;
a hook being coupled to and extending outwardly from said head, said hook having a shank being coupled to a back side of said head and extending towards a bend, an end of said bend having a point and a barb, said point being configured to insert through a fish and said barb is configured to retain the fish within the hook; and
a lead being coupled to said hook and being configured for releasably coupling to a washer and skirt assembly, said lead being positioned proximate to said head, said lead comprising a hexagonal shape configured to secure the washer and skirt assembly within a fixed position upon said hook;
a sleeve being removably couplable to said lure and having a decorative indicia on an exterior of said sleeve, wherein said decorative indicia of said sleeve is configured for attracting fish to said lure, wherein said sleeve removably covers said head of said lure;
a first housing being removably couplable to said wire and enclosing an interior space, said first housing comprising a first shape, said first shape being a willow leaf blade shape, said first housing including a first wall, a second wall, and a perimeter edge, a hole extending through said perimeter edge and being configured for removably coupling to the first coupler, wherein said first housing is removably couplable to said first juncture of said wire;
a first insert being removably insertable within said interior space of said first housing and being configured for attracting fish to said wire, a top side of first insert having a tab coupled to and extending from said top side, said tab being removably positioned within said opening of said first housing when said first insert being removably positioned within said interior space of said first housing, said first insert being a willow leaf blade shape;
said perimeter edge having an opening to said interior space therein such that said first insert is partially surrounded when inserted into said interior space of said first housing;
a second housing being removably couplable to said wire and enclosing a receiving space, said second housing comprising a second shape, said second shape being a Colorado blade shape, said second housing including a primary wall, a secondary wall, and a boundary edge, said boundary edge having an access to said receiving space therein, an aperture extending through said boundary edge and being configured for removably coupling to the second coupler, wherein said second housing is removably couplable to said second juncture of said wire;
a second insert being removably insertable within said receiving space of said second housing and being configured for attracting fish to said wire, an upper side of second insert having a tag coupled to and extending from said upper side, said tag being removably positioned within said access of said second housing when said second insert being removably positioned within said receiving space of said second housing, said second insert being a Colorado blade shape; and
a plurality of reflective members being coupled to said wire and being configured for attracting fish towards said wire, said reflective members being coupled to said first lateral section, said plurality of reflective members being positioned between said first and second junctures, each reflective member comprising a bead having a hollow shaft extending through a center of said bead, wherein said wire is inserted within each reflective member.
